(19) United States
(12) Patent Application Publication
(10) Pub. No.: US 2016/0123527 A1
(43) Pub. Date: May 5, 2016

(54) A DRIVE SUPPORTING STRUCTURE AND A DRIVE SUPPORT ELEMENT

(71) Applicant: OUTOTEC (FINLAND) OY, Espoo (FI)

(72) Inventors: Timo HAUTANIEMI, Espoo (FI); Rami SAARIO, Espoo (FI); Henri FREDRIKSSON, Helsinki (FI); Jussi PAJALA, Vantaa (FI)

(73) Assignee: OUTOTEC (FINLAND) OY, Espoo (FI)

(21) Appl. No.: 14/890,387

(22) PCT Filed: May 12, 2014
(86) PCT No.: PCT/FI2014/050350

§ 371 Date: Nov. 10, 2015

(30) Foreign Application Priority Data
May 13, 2013 (FI) 20135501

(51) Int. Cl. F16M 13/02; B01J 19/00

(52) U.S. Cl. CPC F16M 13/02; B01J 19/0066

(57) ABSTRACT

The invention relates to a drive supporting structure (1) for a tank (2). The drive supporting structure (1) comprises a drive support element (3) for supporting a drive (30) and a support beam structure (4) for supporting the drive support element (3). The support beam structure (4) is arranged on top side of the tank (2) and comprises multiple support beams (5). The drive support element (3) comprises housing (6), which said housing (6) is fabricated by casting. The support beam structure (4) is detachably connected to the drive support element (3) for forming a connection between the drive support element (3) and the support beam structure (4). The invention further relates to a drive support element (3) for supporting a drive in a tank (2). The drive support element (3) comprises housing (6), which is fabricated by casting.

### FIELD OF THE INVENTION

The present invention relates to a drive supporting structure, and more particularly to a drive supporting structure as defined in the preamble of claim 1.

The present invention also relates to a drive support element, and more particularly to a drive support element as defined in the preamble of claim 11.

### BACKGROUND OF THE INVENTION

The present invention relates especially to solvent extraction technology in which solvent extraction tanks are used in a solvent extraction phase of the process. The present invention can also be used in tanks treating solid-liquid, gas-liquid, gas-solid-liquid and liquid-liquid systems for leaching, precipitation, crystallization, oxidation and reduction as well as in solvent extraction. A tank used in above mentioned processes typically comprises a cylindrical side wall, a bottom part and usually but not always a cover part. The tank comprises an agitator arranged inside the tank in the middle part of it. The agitator is arranged to extend vertically in the tank and be operated by an electric motor arranged on top of the tank. The electric motor for rotating the agitator is supported by a separate supporting framework which is on top of the tank.

In the prior art a supporting framework and a drive support are made by I-beams and plates by welding such that a framework with a drive support is formed. Problems with straightness and right height may arise after machining the parts which has to be taken into account to ensure that drive gear fits to the drive support. The welded supporting framework and the welded drive support raise the price of the drive supporting structure because machining is also needed.

### BRIEF DESCRIPTION OF THE INVENTION

An object of the present invention is thus to provide a drive supporting structure and a drive support element so as to alleviate the above disadvantages. The objects of the invention are achieved by a drive supporting structure and a drive support which said drive supporting structure and said drive support are characterized by what is stated in the independent claims. The preferred embodiments of the invention are disclosed in the dependent claims.

The invention is based on the idea of forming at least part of the drive support element as a casting element. The drive support element is for supporting a drive of a tank. Said drive support element is arranged to be connected together with the drive of the tank such that the drive is arranged on top of the drive support element. The drive support element according to the invention is formed as a casting element such that the drive support element comprises a housing which is fabricated by casting. The housing comprises a bottom part and at least one side wall extending from the bottom part. The bottom part comprises at least one aperture through which a drive shaft is arranged to be extended. The drive shaft is arranged to extend vertically in the tank such that one end of the drive shaft extends to the drive support element arranged on top of the tank and through said drive support element such that the drive shaft is connected to the drive, which is arranged onto the drive support element on top of the tank. The drive shaft extends through the drive support element, i.e. through an aperture on the bottom of the housing and from the bottom part of the housing through the housing to the upper part of the drive support element and through an aperture of the upper part. The drive shaft connects with the drive which is arranged on top of the drive support element. In one embodiment of the invention the housing comprises an upper part such that both the housing and the upper part are fabricated as a single piece casting. In another embodiment of the invention the housing is a casting element and an upper part is a separate part which is attachable to the housing either permanently or detachably. The upper part in both cases comprises an aperture for the drive shaft and/or the drive to extend through said aperture. The bottom part of the housing comprises an aperture for the end part of the drive shaft to extend through said aperture inside the housing. The housing in both embodiments is such that it comprises a hollow part inside said housing for the drive shaft.

A benefit with a separate upper part is that height adjustment is possible between the housing and the separate upper part and not between the upper part and a drive.

The invention is based on the idea of forming a drive supporting structure for a tank, which the drive supporting structure comprises a drive support element for supporting a drive and a support beam structure for supporting the drive support element, said support beam structure is arranged on top side of the tank and comprising multiple support beams. The drive support element comprises a housing, which said housing is fabricated by casting, and the support beam structure is detachably connected to the drive support element for forming a connection between the drive support element and the support beam structure.

The drive supporting structure is arranged on top of a tank such that it preferably covers the opening area of the tank. The tank comprises a cover for closing the tank. Nevertheless the drive supporting structure can be arranged on top of the tank. The drive supporting structure comprises support beams which are connected or are connectable to each other in a releasable manner, preferably with a bolt connection. A drive supporting element is arranged to the support beams also in a releasable manner and preferably such that the connection between the drive supporting element and the support beams is between the housing of the drive supporting element and the support beams and the connection is preferably a bolt connection.

An advantage of the drive supporting structure and the drive support element of the invention is that quality of the housing of the drive support element which is fabricated by casting is higher than in the case in which the drive support element is a welded structure. The price is lower for the casting element and the drive supporting structure may be packed and transferred as a split shipment to workshops and then assembled there which reduces a lot of costs. The drive supporting structure according to the invention enables modular product with just one cast element such that other steel parts are connected to the cast element for example with a bolt connection. If a bigger size gear is needed the drive support element can be further machined or replaced with a new one and the same support beam structure can still be used or as alternative the housing of the drive support element can be used and just change the upper part of the housing, i.e. a steel plate or similar. Another advantage with the drive support element comprising a housing fabricated by casting is that the same cast model can be used for the whole gear series.

### BRIEF DESCRIPTION OF THE DRAWINGS

In the following the invention will be described in greater detail by means of preferred embodiments with reference to the attached drawing, in which

FIG. 1 shows a drive supporting structure and a drive support according to the invention.

### DETAILED DESCRIPTION OF THE INVENTION

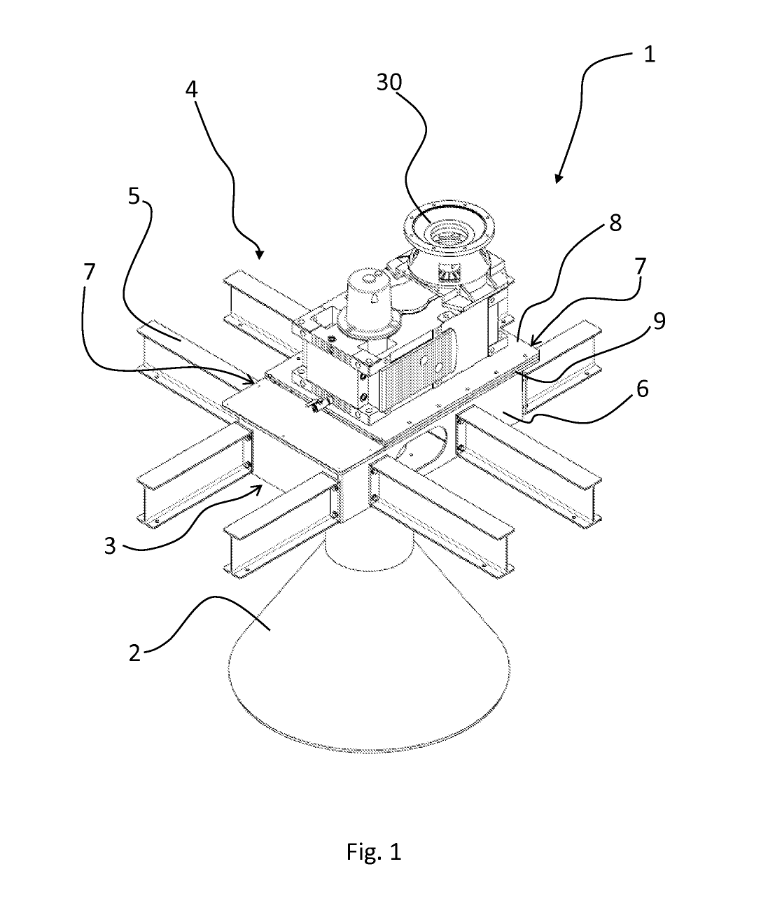

FIG. 1 is shows a drive supporting structure 1 for a tank 2. The drive supporting structure 1 comprises a drive support element 3 for supporting a drive 30 and a support beam structure 4 for supporting the drive support element 3. The support beam structure 4 is arranged on top side of the tank 2 and it comprises multiple support beams 5. The support beams 5 are preferably steel profiles, such as I-beams which are attachable to each other by bolt connections. The bolt connection enables the support beam structure 4 to be disassembled and packed in a package if it needs to be transferred to another place or the support beam structure 4 can be transferred to the working site in a compact package. The bolt connection enables an easy and fast support beam structure 4 assembly in the working site such that no extra time is spent on putting the support beam structure 4 together. The drive support element 3 for supporting a drive 30 in a tank 2 comprises a housing 6, which said housing 6 is fabricated by casting. The housing 6 is a casting element which is connectable to other elements such as to the support beam structure 4 and a gear fastening plate 8 by bolt connections. So the support beam structure 4 is detachably connected to the drive support element 3 for forming a connection between the drive support element 3 and the support beam structure 4.

The drive support element 3 comprising a housing 6 further comprises an upper part 7 attached or arranged to be attached to the housing 6. The upper part 7 may be an integral part of the housing 6 so that the drive support element 3 comprises a housing 6 and an upper part 7 as a one-piece casting element. In another embodiment of the invention the upper part 7 is a separate part from the housing 6 such that the housing is a one-piece casting element and the upper part 7 is a separate element attached or arranged to be attached to the housing 6, preferably with a bolt connection. The upper part 7 is preferably a gear fastening plate 8 through which the drive 30 is arranged or is to be arranged to the drive support element 3. The upper part 7 may also comprise multiple plates in addition to the gear fastening plate 8 which the plates are connected to the housing 6. In case the upper part 7 is a separate element attached or arranged to be attached to the housing 6 it can be changed if for example a drive 30 is changed for a larger one and the upper part 7 must be more robust or otherwise different than the earlier upper part 7. In case the upper part 7 is changed the same housing 6 may still be used and the upper part 7 is easily changed because of the bolt connection. The position of the upper plate 7 can be changed as well as the position of the housing 6 either when being a one-piece casting element together with the upper plate 7 or when being separate elements. When a larger drive 30 is assembled to the drive support element 3 one or more shim plates 9 can be arranged between the housing 6 and the gear fastening plate 8 so that there is enough space for the larger drive 30. In other words the gear fastening plate 8 is moved further away from the housing 6 with one or more shim plates 9. So the drive 30 position can be changed with the shim plates 9.The connection between the drive support element 3 and the support beam structure 4 is preferably a bolt connection. In one embodiment of the invention the bolt connection is such that it allows some relative movements between the support beam structure 4 and the drive support element 3. The drive support element 3 is preferably such that the housing 6 is at least partly hollow inside. The housing 6 comprises preferably a bottom part and side walls in connection with the bottom part and the side walls protruding from the bottom part such that the bottom part and the side walls form an exterior surface of the housing 6 and a hollow part is formed inside the housing 6. The bottom part and the side walls of the housing 6 may comprise one or more through holes. If the drive support element 3 is a one-piece casting element so that the housing 6 and the upper part 7 are one single piece, the hollow inner part is formed such that the bottom part, the side walls and the upper part 7 surround the hollow inner part.

The drive support structure 1 may further comprise a safety cover attached or arranged to be attached to the support beam structure 4. The safety cover is preferably releasable attached to the support beams 5 of the support beam structure 4. The support beams 5 forming the support beam structure 4 are connected to each other with a bolt connection. The drive support element 3 is at least partly movable in relation to said drive support structure 1 such that height position of the drive can be changed. If the drive 30 needs to be changed to a bigger one the height position of the drive support element 3 may be changed or even a different drive support element 3 may be changed to replace the earlier one. It may also be enough to change only the upper part 7 of the drive support element 3.

So the drive support element 3 further comprises an upper part 7 attached or arranged to be attached to the housing 6. The upper part 7 may be attached or is arranged to be attached to the housing 6 with a bolt connection. In that case the housing 6 and the upper part 7 are two separate elements that form the drive support element 3. The height position of the drive 30 can be changed with one or more shim plates 9 arranged between the housing 6 and the upper part 7. The upper part 7 may comprise only one plate, i.e. the gear fastening plate 8, or multiple plates. In one embodiment of the invention the housing 6 comprises an upper part 6, which said housing 6 and said upper part 7 form together a single-piece casting element. In other words the housing 6 comprises an upper part 7 which said housing 6 and said upper part 7 form a single piece casting. The upper part 7 is preferably a gear fastening plate 8 for connecting the drive to the drive support element 3 via said gear fastening plate 8. So the upper part is a gear fastening plate through which the drive is arranged to the drive supporting structure. The upper part 7 preferably comprises an aperture for arranging at least part of the drive or drive components extending inside the drive support element 3. The drive support element 3 is hollow inside such that the housing 6 and the upper part 7 form an exterior of the drive support element 3. The housing 6 comprises at least one notch in the bottom side of the housing 6. The at least one notch can be used for collecting oil leakages or for other reasons.

It will be obvious to a person skilled in the art that, as the technology advances, the inventive concept can be implemented in various ways. The invention and its embodiments are not limited to the examples described above but may vary within the scope of the claims.

1. A drive supporting structure for a tank, which the drive supporting structure comprises:
a drive support element for supporting a drive; and
a support beam structure for supporting the drive support element, said support beam structure is arranged on top side of the tank and comprising multiple support beams, characterized in that the drive support element comprises a housing, which said housing is fabricated by casting, and the support beam structure is detachably connected to the drive support element for forming a connection between the drive support element and the support beam structure, where the drive support element further comprises an upper part attached or arranged to be attached to the housing.

2. (canceled)

3. A drive support structure according to claim 1, characterized in that the upper part is attached or arranged to be attached with a bolt connection to the housing.

4. A drive support structure according to claim 1, characterized in that the upper part comprises one or more plates.

5. A drive support structure according to claim 1, characterized in that one or more shim plates is arranged or can be arranged between the housing and the upper part for changing the height position of the drive (30).

6. A drive support structure according to claim 1, characterized in that the housing comprises an upper part which said housing and said upper part form a single piece casting.

7. A drive support structure according to claim 1, characterized in that the upper part is a gear fastening plate through which the drive is arranged to the drive support element.

8. A drive support structure according to claim 1, characterized in that the connection between the drive support element and the support beam structure is a bolt connection.

9. A drive support structure according to claim 1, characterized in that the drive support structure further comprises a safety cover attached or arranged to be attached to the support beam structure.

10. A drive support structure according to claim 1, characterized in that the support beams forming the support beam structure are connected to each other with a bolt connection.

11. A drive support element for supporting a drive in a tank, characterized in that the drive support element comprises a housing, which is fabricated by casting, where the housing comprises a bottom part and side walls in connection with the bottom part and said side walls protruding from said bottom part.

12. (canceled)

13. A drive support element according to claim 11, characterized in that the drive support element further comprises an upper part attached or arranged to be attached to the housing.

14. A drive support element according to claim 13, characterize in that the upper part is attached or is arranged to be attached to the housing with a bolt connection.

15. A drive support element according to claim 13, characterized in that one or more shim plates is arranged or can be arranged between the housing and the upper part.

16. A drive support element according to claim 11, characterized in that the housing comprises an upper part, which said housing and said upper part form together a single-piece casting element.

17. A drive support element according to claim 11, characterized in that the upper part is a gear fastening plate for connecting the drive to the drive support element via said gear fastening plate.

18. A drive support element according to claim 11, characterized in that the upper part comprises an aperture for arranging at least part of the drive or drive components extending inside the drive support element.

19. A drive support element according to claim 11, characterized in that the drive support element is hollow inside such that the housing and the upper part form an exterior of the drive support element.

20. A drive support element according to claim 11, characterized in that the housing comprises at least one notch in the bottom side of the housing.
